(19) United States
(12) Patent Application Publication
(10) Pub. No.: US 2024/0180141 A1
(43) Pub. Date: Jun. 6, 2024

(54) Method for Spreading Spraying Liquid onto Arable Agricultural Land

(71) Applicant: Amazonen-Werke H. Dreyer SE & Co. KG, Hasbergen (DE)

(72) Inventors: Maximilian HOMANN, Brenken (DE); Timo KLEMANN, Belm (DE); Christoph KÜHN, Bad Iburg (DE); Alexander SILTMANN, Osnabrück (DE); Markus TRENTMANN, Wallenhorst (DE); Maik WERMELING, Rheine (DE)

(73) Assignee: Amazonen-Werke H. Dreyer SE & Co. KG, Hasbergen (DE)

(21) Appl. No.: 18/285,942

(22) PCT Filed: Mar. 25, 2022
(86) PCT No.: PCT/EP2022/057864

§ 371 Date: Oct. 6, 2023

(30) Foreign Application Priority Data
Apr. 8, 2021 (DE) 10 2021 108 731.7

(51) Int. Cl. A01M 7/00; A01C 23/04

(52) U.S. Cl. CPC A01M 7/0089; A01C 23/047; A01M 7/0042

(57) ABSTRACT

A method for spreading a spraying liquid onto arable agricultural land by way of several spreading devices associated with a field sprayer; and arranged along a spraying boom, where the spraying liquid; is applied with a needs-based spreading quantity that is associated with the respective spreading devices where at least one first operating parameter associated with at least one first spreading device; and at least one second operating parameter associated with at least one second spreading device is determined, and where a difference between the operating parameters is ascertained and/or detected, and where the first and/or second operating parameter is adjusted if the difference is outside an acceptance range, where the difference is within the acceptance range after adjustment. In order to further improve the spreading process, it is provided that at least one of several control strategies is selected, where the at least one first and/or second operating parameter is adjusted as a function of the selected control strategy.

### CROSS REFERENCE TO RELATED APPLICATIONS

The present application claims priority under 35 U.S.C. § 365 to PCT/EP2022/057864 filed on Mar. 25, 2022 and under 35 U.S.C. § 119(a) to German Application No. 10 2021 108 731.7 filed on Apr. 8, 2021.

### BACKGROUND

The disclosure relates to a method for spreading a spraying liquid onto arable agricultural land and an agricultural field sprayer for spreading a spraying liquid onto arable agricultural land.

A plurality of variants of towed, mounted, and/or self-propelled working machines is known in the field of agriculture. These include, inter alia, distribution machines configured as agricultural sprayers, in particular field sprayers, which are suitable for dispensing a spraying liquid onto arable agricultural land. The spraying liquid is generically configured as a weed control agent, plant protection agent and/or fertilizer and is intended to be spread onto the arable agricultural land and/or its plant population.

Due to the relatively large dimensions of arable agricultural land, such agricultural sprayers typically have at least one spraying boom extending to be transverse to a direction of travel and in particular being foldable. A plurality of spreading devices, in particular in the form of spray nozzles and/or switching elements, by way of which the spraying liquid is spread onto the arable agricultural land as required, in particular specific to a partial area, are arranged along the spraying boom. In addition, at least one fluid-conducting delivery line and at least one, in particular central, delivery unit are arranged upstream of the spreading devices and are suitable for delivering the spraying liquid in an adjustable manner from the at least one storage container to the respective spreading devices. The spreading process of the spraying liquid is furthermore influenced as required and by way of at least one operating parameter that can be adjusted and is associated with the respective spreading devices.

Such a method is described, for example, in EP 1 346 637 A1. According thereto, methods for spreading the spraying liquid as required, in particular controlled with nozzles in open-loop and/or closed-loop manner, are known. The spraying liquid is there spread as a function of at least one first operating parameter associated with at least one first spreading device, in particular a first spreading quantity, and at least one second operating parameter associated with at least one second spreading device, in particular a second spreading quantity.

The operating parameters, in particular the spreading quantity, of the respective spreading devices are to be adjusted by an operator and/or an open-loop and/or closed-loop control system associated with the spraying device, in particular the field sprayer, in such a way that the spraying liquid is spread from the respective spreading devices in the intended and/or required manner to the arable agricultural land and/or the plant population. The demand for spraying liquid differs, inter alia, due to the respective condition, type, and/or number, in particular density, of the plant population in the respective areas of the arable land. Furthermore, due to the, in particular fluctuating, speed at which the respective spreading devices are moved above the arable land and/or the plant population, it is also necessary to vary the operating parameters, in particular the spreading quantities. In addition to agricultural crops, the plant population of the arable land is understood according to the disclosure to mean, alternatively or additionally, weeds and/or the like.

During the spreading process, however, situations often arise in which the need for spraying liquid along the boom, in particular the spreading devices arranged thereon, fluctuates and/or differs from one another in such a way that at least one operating parameter that is to be set and/or is required can at least nearly not be reached by at least one of the spreading devices and/or cannot be adjusted due to reasons in the system. As a result, proper spreading, for example to form a spray fan originating from the spreading devices, can therefore no longer be implemented. Such situations often occur with modern sprayers during the spreading process when cornering or when using application maps.

A method is known from publication U.S. Pat. No. 5,134,961 A, in which, inter alia, a difference between the operating parameters, in particular the spreading quantities, is ascertained and/or detected. If the difference is outside of an, in particular defined, acceptance range, the first and/or second operating parameter, in particular the first and/or second spreading quantity, is adjusted, where the difference after the adjustment, in particular due to the correction of the first and/or second operating parameter, is within the acceptance range.

Such methods and/or spraying devices carry out such an adjustment, in particular a correction, of the operating parameters, in particular of the spreading quantities, according to at least one determination and/or calculation operation which is generally fixedly predetermined by the manufacturer. The adjustment, in particular the correction, has thus far always represented a compromise which leads to a spreading process, in particular spreading quality, that is still just acceptable in the different spreading situations.

### SUMMARY

In a plurality of such spreading situations, however, the spreading process, in particular the flexibility of such spraying devices and/or spreading methods, could be further improved if the operator or farmer could influence such adjustments, in particular corrections, in a particularly simple manner, in particular on the basis of different conditions and/or empirical values.

This object is satisfied according to the disclosure in that at least one of several, in particular predetermined, control strategies is selected, where the at least one first and/or second operating parameter, in particular the at least one first and/or second spreading quantity, is adjusted, in particular corrected, as a function of the selected control strategy.

As a result of this measure, it is specified for the open-loop and/or closed-loop control system at least temporarily, preferably until the end of spreading process and/or beyond, from a number of options as to how the operating parameters, in particular the spreading quantities, are adjusted and/or corrected. The control strategy preferably determines whether only the first operating parameter associated with the at least one first spreading device, in particular the first spreading quantity, or alternatively or additionally the second operating parameter associated with the second, in particular other, spreading device, in particular the second spreading quantity, is adjusted and/or corrected by the difference when the acceptance range is exceeded. Alternatively or additionally, the control strategy determines the control sensitivity and/or the control speed with which the adjustment and/or correction of the operating parameters, in particular of the spreading quantities, is carried out. The respective control strategy particularly preferably determines the proportions and/or direction in which a respective operating parameter, in particular a respective spreading quantity, is adjusted and/or corrected. In other words, it is preferably determined there whether the operating parameters, in particular the spreading quantities, are increased or reduced, in particular on average, in the event of an adjustment and/or correction. The operating parameters are adjusted and/or corrected in such a way that the difference is reduced at least in part and/or is within the acceptance range. The control strategy is particularly preferably selected and/or predetermined, in particular manually, by the operator using an input and/or display device associated with the spraying device, in particular a mobile touch display and/or a mobile radio device.

An operating parameter is preferably understood to be a variable that is relevant to flow and/or is associated with at least one spreading device and represents and/or influences at least in part an amount of spraying liquid, in particular a spreading amount, that can be spread by at least one spreading device. The operating parameter particularly preferably represents the spreading quantity itself of the respective spreading agent. In particular, the first operating parameter therefore represents the spreading quantity of the at least one first spreading device, while the second operating parameter represents the spreading quantity of the at least one second spreading device. Alternatively or additionally, the operating parameter is to be understood to mean a pressure and/or volume flow. Depending on the preferred embodiment variant, the operating parameter is determined in relation to at least one spreading device or alternatively in relation to a plurality of spreading devices, in particular for a group or partial width of spreading devices. The operating parameters are also preferably retrieved, entered, and/or ascertained, in particular within the determination and/or calculation algorithms that can be executed by the open-loop and/or closed-loop control system. Alternatively or additionally, the operating parameters can also be detectable and/or be detected by sensors, in particular by way of at least one sensor device, for example, by way of flow and/or pressure sensors associated with at least one spreading device.

Furthermore, the operating parameter can alternatively or additionally also be understood to be the composition of the spraying liquid that can be spread from the respective at least one spreading device. The spraying liquid is preferably composed of a specific proportion of at least one carrier liquid, in particular water, and a further specific proportion of at least one active ingredient, in particular a weed control agent, plant protection agent, and/or fertilizer. The respective proportions of the carrier liquid and of the at least one active substance can be adjusted for the respective spreading devices, in particular by nozzles and/or by the partial width by way of associated metering elements.

In a further preferred embodiment of the method according to the disclosure, the spraying agent, in particular the adjustable composition of the spraying agent, is influenced and/or adjusted as a function of the selectable control strategy.

Unless explicitly stated otherwise, the term “acceptance range” according to the disclosure denotes preferably a permissible range for the, in particular determined, operating parameters and/or the, in particular ascertained and/or detected, difference between a minimum and maximum operating parameter and/or difference. Alternatively or additionally, the term “acceptance range” denotes a maximum and/or minimum threshold value for the, in particular determined, operating parameter, and/or the, in particular ascertained and/or detected, difference. The acceptance range is preferably determined temporarily or alternatively statically for the entire spreading process or beyond that by the operator and/or the open-loop and/or closed-loop control system for at least one spreading device, preferably all spreading devices. Alternatively or additionally, the acceptance range can also be variably adjustable at least in part, in particular within a defined tolerance range, by the open-loop and/or closed-loop control system during the spreading process, in particular as a function of different environmental conditions and/or operating conditions.

The spreading devices are preferably formed as switching elements or valves and/or spray nozzles, in particular in the form of single or multiple nozzle bodies. The spreading quantity of the respective spreading devices is preferably controlled in an open-loop and/or closed-loop manner, in particular individually or specific to partial areas, for each spreading device individually by groups or by partial widths for a plurality of spreading devices. The spreading quantity is also preferably determined as a function of different operating and/or environmental conditions, an application map that can be stored and/or retrieved, the speed of the spraying device, and/or the, in particular individual, spreading devices and/or as a function of the condition, type, and/or the level of development of the plant population.

In a preferred embodiment of the method according to the disclosure, the control strategy can be selected from at least two, in particular at least three, control strategies. In a preferred first control strategy, a smaller operating parameter from the first or second operating parameter is adjusted and/or corrected in the direction of a greater operating parameter. For example, a determined and/or detected minimum spreading quantity is adjusted and/or corrected in the direction of a greater, in particular maximum, spreading quantity, while the greater, in particular maximum, spreading quantity is at least approximately maintained and/or kept constant. In a further preferred second control strategy, a greater operating parameter from the first or second operating parameter is adjusted and/or corrected in the direction of a smaller operating parameter. For example, a determined and/or detected maximum spreading quantity is adjusted and/or corrected in the direction of a smaller, in particular minimum, spreading quantity, while the smaller, in particular minimum, spreading quantity is at least approximately maintained and/or kept constant. In a further preferred third control strategy, the smaller operating parameter is adjusted and/or corrected in the direction of the greater operating parameter as well as the greater operating parameter is adjusted and/or corrected in the direction of the smaller operating parameter. For example, a detected and/or determined minimum spreading quantity is increased and a detected and/or determined maximum spreading quantity is reduced. The adjustment and/or correction of the operating parameters in the preferred third control strategy can be carried out in equal or unequal proportions for the respective operating parameters, so that, for example, in particular optionally, the greater operating parameter is adjusted and/or corrected to a larger or smaller proportion than the smaller operating parameter.

Alternatively or additionally, a great or greater operating parameter can also be understood to mean a composition of the spraying liquid with a higher proportion of active substance to the carrier liquid, while a small or smaller operating parameter is understood to mean a composition of the spraying liquid with a lesser proportion of active substance to the carrier liquid. Therefore, for example, the active substance concentration within the spraying liquid that can be spread can alternatively or additionally also be adjusted and/or corrected, in particular by nozzle and/or by the partial width, as a function on the selectable control strategy.

Furthermore, an alternative or additional embodiment of the method according to the disclosure is preferred in which several different first operating parameters are associated with at least one first spreading device and several different second operating parameters are associated with at least one second spreading device. The respective control strategy there preferably determines which and/or how many of the different operating parameters respectively associated with a spreading device are adjusted. For example, one of several operating parameters associated with a spreading device can represent a flow quantity of the spraying liquid, while another of several operating parameters represents the flow pressure, the composition of the spraying liquid, and/or one of the other operating parameters mentioned by way of example.

In a further preferred embodiment of the method according to the disclosure, at least one control strategy is proposed to the operator on the basis of at least one ambient condition detected, preferably by sensors, and/or a previously executed selection. The control strategy is preferably preselected and/or displayed, in particular marked, on the input and/or display device. The environmental condition can there be the condition, type, and/or growth stage of at least one plant in the plant population. Furthermore, the environmental condition can alternatively or additionally also be a degree of wetting, in particular detectable by sensors, of at least one surface of a plant that has already been treated or wetted with spraying liquid. Alternatively or additionally, soil values such as soil temperature, soil moisture, and/or soil composition are also conceivable as environmental conditions Alternatively or additionally, the environmental condition can also be the weather, in particular the ambient temperature, humidity, and/or the air movements. Furthermore, such an environmental condition can also be regarded as an operating condition in the manner of a speed of travel of the spraying device and/or a speed over ground of at least one spreading device. In addition, the control strategy is proposed taking into account previously executed selections, for example, based on selection records from a previous day and/or a previous season. In particular, a deep learning and/or AI method is used for such a proposal of a control strategy, preferably for taking into account a selection pattern and therefore the preferences of at least one operator.

In a further preferred embodiment of the method according to the disclosure, at least one control strategy that can be freely configured and/or adjusted by the operator can be selected. A control strategy that is already predetermined and/or proposed is preferably adjusted by the operator. Alternatively or additionally, at least one further, in particular adjusted and/or provided, control strategy can also be retrieved and/or selected from a memory and/or by remote access.

In a further development of the method according to the disclosure, at least one maximum and/or minimum operating parameter is ascertained and/or retrieved taking into account the acceptance range of the difference. The at least one first and/or second operating parameter is adjusted as a function of the control strategy, in particular if at least one operating parameter associated with the spreading devices exceeds the maximum operating parameter or undercuts the minimum operating parameter. The at least one operating parameter associated with a respective spreading device there preferably represents a nozzle size, a nozzle type, and/or an opening and/or closing time or duration of the respective spreading device. Furthermore, the at least one operating parameter associated with a spreading device preferably represents a pressure directly forward of the at least one spreading device, the group and/or partial width of spreading devices, and/or the overall system, in particular within the spraying device. Alternatively, exceeding or undercutting a maximum or minimum operating parameter can also mean the, in particular determined, first and/or second operating parameter reaching the maximum or minimum operating parameter.

In another preferred embodiment of the method according to the disclosure, the spreading devices can be controlled in an open-loop and/or closed-loop manner and in the manner of pulse width and/or pulse width frequency modulation, where the at least one operating parameter is preferably embodied as a duty cycle and/or as a pulse frequency. A first duty cycle and/or a first pulse frequency is preferably determined for the at least one first spreading device and a second duty cycle and/or a second pulse frequency for the at least one second spreading device. A maximum and/or minimum duty cycle associated with at least one spreading device, preferably all spreading devices, is particularly preferably determined and/or predetermined there, which represents in particular the permissible acceptance range for the first and/or second operating parameter. If, for example, the first and/or second duty cycle is above or below the maximum or minimum duty cycle, then the first and/or second duty cycle is adjusted and/or corrected as a function of the control strategy selected. Alternatively or additionally, a pressure of the spraying liquid that is directly present in the region of the respective spreading device is taken into account as an operating parameter and thereby as an, in particular permissible, maximum and/or minimum pressure.

In another further development of the method according to the disclosure, at least one spreading device is detected and/or ascertained in which a specific operating parameter, in particular a setpoint operating parameter, is at least nearly not reached and/or cannot be adjusted by the adjusted, in particular current, operating parameter. This can be the case, for example, where the determined operating parameter, in particular setpoint operating parameter, and/or the determined difference, in particular setpoint difference, is outside the acceptance range and can therefore not be adjusted and/or controlled. Preferably, the at least one spreading device and/or the adjusted, in particular current, operating parameter, at which the determined operating parameter, in particular setpoint operating parameter, is at least nearly not reached and/or cannot be adjusted, is visualized. The visualization is preferably carried out in the manner of, in particular graphical, highlighting and/or marking on the associated input and/or display device. Alternatively or additionally, the deviation and/or difference between the current operating parameter, in particular the current spreading quantity, and the determined, in particular setpoint, operating parameter, preferably the setpoint spreading quantity, is displayed.

The object underlying the disclosure is also satisfied by an agricultural field sprayer of the kind mentioned at the outset, where at least one of several control strategies can be selected, and the first and/or second operating parameter can be adjusted and/or corrected as a function of the respective control strategy. With regard to the advantages and modifications of the field sprayer according to the disclosure, reference is first made to the advantages and modifications of the method according to the disclosure.

According thereto, the field sprayer for spreading a spraying liquid onto arable agricultural land comprises at least one storage container for storing the spraying liquid and at least one spraying boom aligned to be transverse to a direction of travel. Furthermore, the field sprayer comprises at least one first and second spreading device, which are connected to the storage container in a fluid-conducting manner and are arranged along the spraying boom. The spraying liquid can be spread with a determinable first operating parameter via the first spreading device and with a determinable second operating parameter via the second spreading device. A open-loop and/or closed-loop control system associated with the field sprayer and configured to control the at least one first and second operating parameter in an open-loop and/or closed-loop manner, is furthermore configured to adjust and/or correct the first and/or second operating parameter when an, in particular predeterminable, maximum difference is reached or undercut.

In a preferred embodiment of the field sprayer according to the disclosure, the open-loop and/or closed-loop control system is configured to carry out at least in part the method according to at least one of the aforementioned embodiments of the method according to the disclosure.

### BRIEF DESCRIPTION OF THE DRAWINGS

Further details of the disclosure can be gathered from the description of the examples and the drawings, where the drawing in

FIG. 1 shows a spraying device according to at least one embodiment of the invention configured as a carried agricultural field sprayer in a perspective view from behind during the spreading process;

FIG. 2 shows the field sprayer from FIG. 1 from behind with a schematic representation of operating parameters, in particular spreading quantities;

FIG. 3 shows a visualization according to at least one embodiment of the invention on an input and/or display device associated with the field sprayer; and

FIG. 4 4 shows a schematic flowchart of a method according to at least one embodiment of the invention.

### DETAILED DESCRIPTION

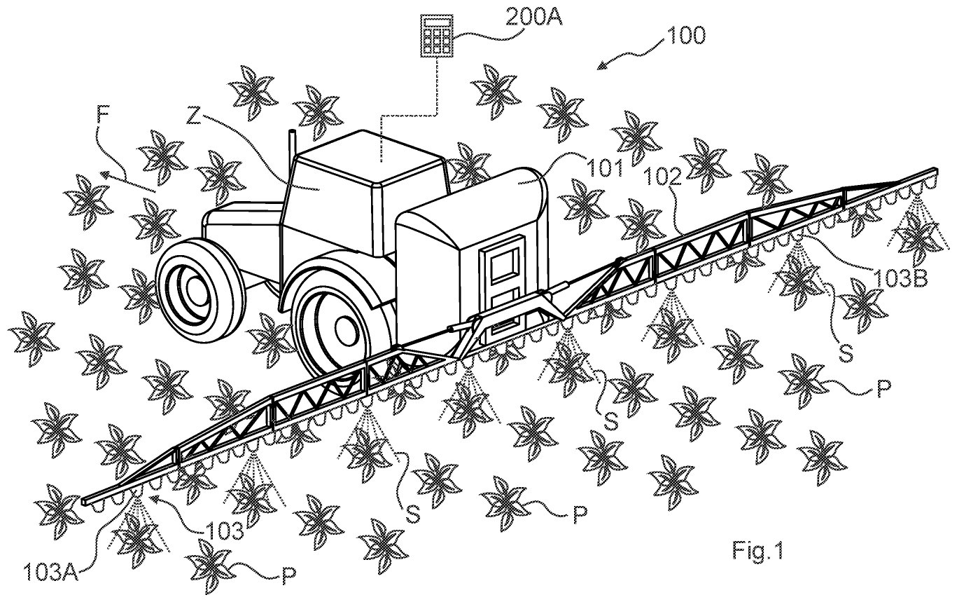

An agricultural field sprayer 100 for spreading a spraying liquid S, in particular plant protection agents and/or fertilizer, onto arable agricultural land and/or a plant population P is shown in FIG. 1. Field sprayer 100 is configured to be able to be carried by a tractor Z, where a towed and/or self-propelled field sprayer 100 is also conceivable as an alternative thereto.

Field sprayer 100 comprises at least one storage container 101 for storing spraying liquid S and at least one, in particular foldable, spraying boom 102 which is aligned to be transverse to a direction of travel F. Furthermore, field sprayer 100 comprises at least one first and second spreading device 103A, 103B of a plurality of spreading devices 103 which are connected to storage container 101 in a fluid-conducting manner and are arranged along spraying boom 102. Field sprayer 100 furthermore comprises a delivery system (not shown in the Figures), consisting of at least one delivery device, in particular a delivery pump, and at least one delivery line for supplying spraying liquid S to spreading devices 103 as required and/or in an adjustable manner. Spraying liquid S can be spread in the form of a spraying fan, which emanates from and/or can be generated by respective spreading devices 103, onto the arable agricultural land and/or the plant population P or applied thereonto.

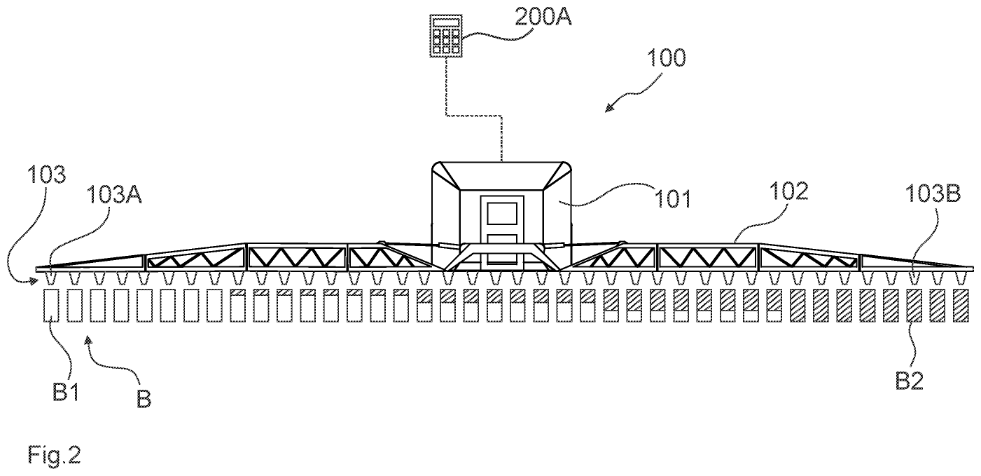

As can be seen in FIG. 2, spraying liquid S can be spread as a function of at least one determinable first operating parameter B1 via first spreading device 103A and at least one determinable second operating parameter B2 via second spreading device 103B. An open-loop and/or closed-loop control system 200A associated with field sprayer 100 and configured to control at least one first and second operating parameter B1, B2 in an open-loop and/or closed-loop manner is furthermore configured to adjust and/or correct first and/or second operating parameter B1, B2 when an, in particular predeterminable maximum difference between first and/or second operating parameter B1, B2 is reached or undercut. Open-loop and/or closed-loop control system 200A is beyond that configured to verify whether the difference between at least one first and second operating parameter B1, B2 before and/or after the adjustment and/or correction is within and/or outside of an, in particular predeterminable, acceptance range.

At least one first and/or second operating parameter B1, B2 can be adjusted and/or corrected by open-loop and/or closed-loop control system 200A as a function of at least one of several selectable control strategies. In this embodiment, the control strategy can be selected by an operator or farmer using input and/or display device 200B associated with open-loop and/or closed-loop control system 200A and/or field sprayer 100. As an alternative or in addition thereto, the control strategy can be selected, in particular in an automated manner, by open-loop and/or closed-loop control system 200A. The control strategy is selected in advance, in particular prior to the spreading process, and is determined until the end of the spreading process or beyond. As an alternative or in addition thereto, the control strategy can also be adjustable and/or selectable, in particular temporarily, during the spreading process.

Operating parameters B1, B2 described in this embodiment are configured as the spreading quantity of spraying liquid S and are shown schematically in a bar graph in FIG. 2 below spraying boom 102, in particular associated with each spreading device 103. A bar that is filled in downwards, in particular is solid, symbolizes a high or higher value of operating parameters B1, B2, in particular of the spreading quantities, whereas a bar that is slightly filled in, in particular is empty, symbolizes a small or smaller operating parameter B1, B2, in particular a smaller spreading quantity. Spreading devices 103 are configured there, for example, as spray nozzles with at least one associated switching element. As an alternative or in addition thereto, spreading devices 103 could also be configured as switching elements, in particular valves, arranged at field sprayer 100. In this embodiment, first spreading device 103A is selected by way of example as first spreading device 103 when viewed from the left. In this embodiment, second spreading device 103B represents the third-to-last spreading device 103 from the left. Alternatively or in addition thereto, first and/or second spreading device 103A, 103B can also be any other spreading device 103 arranged on spraying boom 102.

First and/or second operating parameters B1, B2, in particular the spreading quantities, can there be ascertained and/or determined by open-loop and/or closed-loop control system 200A, where they can alternatively or additionally also be retrieved, in particular by way of a storable application map. Operating parameters B1, B2 or spreading quantities, respectively, can be ascertained and/or measured in particular by way of at least one sensor device associated with field sprayer 100, in particular with respective spreading devices 103.

As an alternative or in addition to the embodiment shown, spreading devices 103 can be controlled in an open-loop and/or closed-loop manner and in the manner of pulse width and/or pulse width frequency modulation, where at least one first and/or second operating parameter B1, B2 is alternatively or additionally embodied as a duty cycle associated with spreading devices 103 and/or as a pulse frequency. At least a maximum and/or minimum duty cycle and/or a maximum and/or minimum pulse frequency can be predetermined to define the permissible acceptance range and/or the maximum difference between operating parameters B1, B2. Operating parameters B1, B2 can also alternatively or additionally be implemented as the pressure of spraying liquid S, in particular in the immediate vicinity of spreading devices 103.

It can furthermore be seen in FIG. 2 that the bar associated with first spreading device 103A is only slightly filled or empty, whereas the bar associated with second spreading device 103B is filled more or full. Therefore, in this situation illustrated, which presently represents cornering performing a left turn by way of example, first operating parameter B1, in particular the first spreading quantity, is less than second operating parameter B2, in particular the second spreading quantity. If the difference between operating parameters B1, B2 presently shown exceeds the permissible acceptance range, then operating parameters B1, B2 are consequently adjusted and/or corrected on the basis of the selected and/or predetermined control strategy. As an alternative or in addition thereto, the difference can also be outside the acceptance range if first and/or second operating parameter B1, B2 exceeds or undercuts at least one, in particular predeterminable, permissible threshold value.

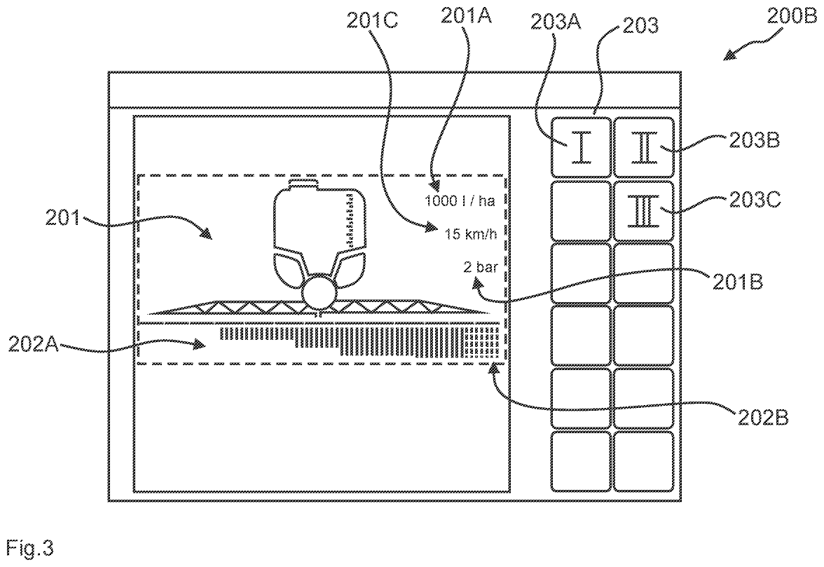

FIG. 3 shows an example of input and/or display device 200B which is associated with field sprayer 100 and/or open-loop and/or closed-loop control system 200A and is presently embodied as a mobile touch terminal. As an alternative or in addition thereto, input and/or display device 200B can also be embodied as a mobile and portable input device, in particular as a smartphone. Input and/or display device 200B shows a first control and/or display region 201 and a second control and/or display region 203. Visible inside first control and/or display region 201 is a schematic representation of field sprayer 100 from FIG. 2. Visible below field sprayer 100 shown schematically in first control and/or display region 201 are furthermore bars 202A which are dependent on a current variable of operating parameters B1, B2 associated with spreading devices 103. The situation and/or operating parameters B1, B2 correspond approximately to the situation and/or operating parameters B1, B2 from FIG. 2, where at least one second operating parameter B1 there cannot be adjusted by open-loop and/or closed-loop control system due to the maximum difference and/or the permissible acceptance range. In particular, a determined and/or predetermined operating parameter, in particular a setpoint operating parameter, can at least nearly not be reached and/or adjusted by at least one current and/or second operating parameter B2. At least one second operating parameter B2, in particular a plurality of second and/or impermissible operating parameters 202B, which do not reach the determined operating parameter, are visualized there to the operator. The visualization is presently implemented in the form of graphic highlighting and/or marking. As an alternative or in addition, other graphical representations and/or acoustic signals are also conceivable. In addition to the schematic representation of field sprayer 100, first control and/or display region 201 also displays a current total spreading quantity 201A of spraying liquid S, a current pressure 201B, in particular of the overall system and/or in the region of respective spreading devices 103, and/or a current speed of travel 201C.

Second control and/or display region 203 shown in FIG. 3 represents by way of example a selection option of at least one of several control strategies. A first control strategy can there be selected via a first control and/or touch panel 203A, a second control strategy via a second control and/or touch panel 203B, and/or a third control strategy via a third control and/or touch panel 203C. As an alternative thereto, it is also possible to select more or fewer control strategies. Furthermore, the selection can alternatively or additionally be carried out without contact, in particular by way of voice input.

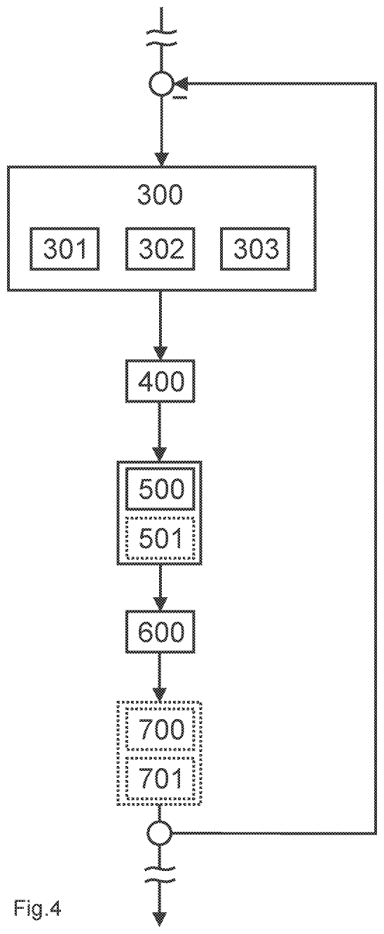

FIG. 4 shows a flow chart according to at least one embodiment of a method for spreading spraying liquid S onto arable agricultural land and/or the plant population P by way of multiple spreading devices 103 associated with field sprayer 100 and arranged along spraying boom 102.

In advance to the spreading process or before starting the method, the operator alternatively or additionally predetermines and/or sets an intended speed of travel, an intended pressure, in particular within the overall system and/or in the region of the respective spreading devices 103, and/or an intended total spreading quantity of the spraying liquid.

The method according to the disclosure is then initiated by the step of:
300) selecting at least one of several, in particular predetermined, control strategies.

The control strategy is selected from at least two of the following control strategies:
301) a first control strategy in which a smaller operating parameter B1, B2 from first or second operating parameter B1, B2 is adjusted and/or corrected in the direction of a greater operating parameter B1, B2.
302) a second control strategy in which a greater operating parameter B1, B2 from first or second operating parameter B1, B2 is adjusted and/or corrected in the direction of a smaller operating parameter B1, B2.
303) a third control strategy in which smaller operating parameter B1, B2 is adjusted and/or corrected in the direction of greater operating parameter B1, B2 as well as greater operating parameter B1, B2 in the direction of smaller operating parameter B1, B2.

As an alternative or in addition to this step, at least one control strategy is proposed to the operator on the basis of at least one ambient condition detected, preferably by sensors, and/or a previously executed selection. Furthermore, the control strategy that can be selected, in particular in step 300), can alternatively or additionally be freely configurable and/or adjustable by the operator.

Once the control strategy is selected and/or defined for the spreading process, the following steps are performed:
400) determining at least one first operating parameter B1 associated with at least one first spreading device 103A, in particular a first spreading quantity, and at least one second operating parameter B2 associated with at least one second spreading device 103B, in particular a second spreading quantity; and
500) ascertaining and/or detecting a difference between operating parameters B1, B2, in particular the spreading quantities.

Step 500) can there also be supplemented or replaced according to the disclosure by the following step:
501) ascertaining and/or retrieving at least one maximum and/or minimum operating parameter, taking into account the acceptance range of the difference

Once a difference between at least one first and second operating parameter B1, B2 is ascertained and/or detected, the following step is carried out:
600) adjusting first and/or second operating parameter B1, B2, in particular the first and/or second spreading quantity, if the difference is outside an acceptance range, which is defined in particular.

Operating parameters B1, B2, in particular the first and/or second spreading quantity, are consequently adjusted and/or corrected as a function of the control strategy previously selected, in particular at the beginning.

In particular, operating parameters B1, B2 are adjusted and/or corrected according to the control strategy selected in advance during all spreading situations, for example, for cornering, spreading based on an application map, for manual input by an operator and or for automated specifications based on environmental and/or operating conditions ascertained by sensor in which the difference and/or operating parameters B1, B2 exceed a permissible acceptance range, in particular a maximum and/or minimum operating parameter.

In particular, a permissible maximum difference and/or an, in particular temporarily variable, acceptance range is ascertained and/or predetermined by open-loop and/or closed-loop control system 200A on the basis of at least one of the specifications described above, in particular the speed of travel, the pressure, and/or the total spreading quantity. As an alternative or in addition thereto, a minimum and/or maximum operating parameter, representing a threshold value for first and/or second operating parameter B1, B2 is ascertained and/or predetermined accordingly.

Alternatively or additionally, the method is supplemented by at least one of the following:
700) detecting and/or ascertaining at least one spreading device 103 in which a determined operating parameter, in particular setpoint operating parameter, is at least nearly not reached by the adjusted, in particular current, operating parameter B1, B2; and/or
701) visualizing at least one spreading device 103 and/or adjusted, in particular current, operating parameter B1, B2 for which the determined operating parameter, in particular setpoint operating parameter, is at least nearly not reached and/or cannot be adjusted.

All the steps described above can be repeated over and over again during the spreading process.

It goes without saying that the features mentioned in the embodiments described above are not restricted to these special combinations and are also possible in any other combination. Furthermore, it goes without saying that the geometries shown in the figures are only by way of example and are also possible in any other configuration.

### LIST OF REFERENCE CHARACTERS

100 agricultural field sprayer
101 storage container
102 spraying boom
103 spreading device
103A first spreading device
103B second spreading device
200a open-loop and/or closed-loop control system
200B input and/or display device
201 first control and/or display region
201A current total spreading quantity
201B current pressure
201C current speed of travel
202A schematic operating parameters
202B schematic impermissible operating parameters
203 second control and/or display region
203A first control and/or touch panel
203B second control and/or touch panel
203C third control and/or touch panel
B bar graph of the operating parameters
B1 first operating parameter
B2 second operating parameter
F direction of travel
P plant population
S spraying liquid
Z tractor

1. A method for spreading a spraying liquid onto arable agricultural land by way of several spreading devices associated with a field sprayer; and arranged along a spraying boom, where said spraying liquid is applied with a needs-based spreading quantity that is associated with the respective spreading devices comprising:
determining at least one first operating parameter associated with at least one first spreading device, and at least one second operating parameter; associated with at least one second spreading device;
ascertaining and/or detecting a difference between said operating parameters;
adjusting said first and/or second operating parameter if the difference is outside a defined; acceptance range; where said difference is within the acceptance range after adjustment; due to a correction of said first and/or second operating parameter, wherein
selecting at least one of several predetermined; control strategies, where said at least one first and/or second operating parameter is adjusted as a function of said selected control strategy.

2. The method according to claim 1, wherein said control strategy can be selected from at least two of the following control strategies:
a first control strategy in which a smaller operating parameter from said first or second operating parameter is adjusted and/or corrected in the direction of a greater operating parameter;
a second control strategy in which a greater operating parameter from said first or second operating parameter is adjusted and/or corrected in the direction of a smaller operating parameter; and
a third control strategy in which said smaller operating parameter is adjusted and/or corrected in the direction of said greater operating parameter as well as said greater operating parameter in the direction of said smaller operating parameter.

3. The method according to claim 1, wherein at least one control strategy is proposed to the operator on the basis of at least one ambient condition detected, preferably by sensors, and/or a previously executed selection.

4. The method according to claim 1, further including:
ascertaining and/or retrieving at least one maximum and/or minimum operating parameter, taking into account the acceptance range of the difference;
wherein said at least one first and/or second operating parameter Bile is adjusted as a function of said control strategy if at least one operating parameter associated with said spreading devices exceeds the maximum operating parameter or undercuts the minimum operating parameter.

5. The method according to claim 1, wherein said spreading devices can be controlled in an open-loop and/or closed-loop manner and in a manner of a pulse width and/or pulse width frequency modulation, where said at least one operating parameter is preferably embodied as a duty cycle and/or as a pulse frequency.

6. The method according to claim 1, further including at least one of the following:
detecting and/or ascertaining at least one spreading device in which a determined operating parameter is at least nearly not reached by said adjusted operating parameter; and/or
visualizing said at least one spreading device and/or said adjusted operating parameter for which said determined operating parameter is at least nearly not reached.

7. An agricultural field sprayer for spreading a spraying liquid onto arable agricultural land comprising,
at least one storage container for storing said spraying liquid,
at least one spraying boom aligned to be transverse to a direction of travel,
at least one first and second spreading device, which are connected to said storage container in a fluid-conducting manner and are arranged along said spraying boom, where said spraying liquid can be spread with a determinable first operating parameter via said first spreading device and with a determinable second operating parameter via said second spreading device, and
at least one associated open-loop and/or closed-loop control system configured to control said at least one first and second operating parameter in an open-loop and/or closed-loop manner, and where said open-loop and/or closed-loop control system is configured to adjust and/or correct said first and/or second operating parameter when a predeterminable maximum difference is reached or undercut, wherein at least one of several of control strategies can be selected, and that said first and/or second operating parameter can be adjusted and/or corrected as a function of said respective control strategy.

8. The Field sprayer according to claim 7, wherein said open-loop and/or closed-loop control system is configured to carry out at least in part the method according to at least one of the aforementioned claim 1.
